(19) United States
(12) Patent Application Publication
(10) Pub. No.: US 2017/0011442 A1
(43) Pub. Date: Jan. 12, 2017

(54) METHOD AND SYSTEM FOR AUTOMATED FOOD AND BEVERAGE SERVING

(71) Applicant: Cafe X Technologies Limited, Hong Kong (HK)

(72) Inventors: Xiaoning Henry Hu, Hong Kong (HK); Ho Hin Jack Sun, Hong Kong (HK); Ping Yuen Kwan, Hong Kong (HK)

(21) Appl. No.: 15/201,599

(22) Filed: Jul. 4, 2016

Related U.S. Application Data
(60) Provisional application No. 62/191,490, filed on Jul. 12, 2015.

(51) Int. Cl. G06Q 30/06; G06Q 20/10

(52) U.S. Cl. CPC G06Q 30/0621; G06Q 20/102; G06Q 30/0635; G06Q 50/12

(57) ABSTRACT

Disclosed is a system and method for automated serving of one or more items. According to the system and method, a central controller may initially capture order details associated to an order placed by a user for serving an item. A control system may trigger one or more item producing components along with a robot unit to collectively process the order in order to produce the item based upon the order details. Further, the control system may determine a hold zone position available from multiple hold zone positions in a predefined hold zone for holding the item corresponding to the order. Further, the robot unit may move the item produced corresponding to the order in the said hold zone position of the hold zone. The robot unit may dispense the item from the said hold zone position into a delivery bay engine thereby serving the item to the user.

### CROSS-REFERENCE TO RELATED APPLICATIONS AND PRIORITY

The present application claims priority from U.S. Provisional Patent Application No. 62/191,490 filed on Jul. 12, 2015, incorporated herein as a reference.

### TECHNICAL FIELD

The present subject matter described herein, in general, relates to automated system and method for serving one or more items, and more particularly for serving food and beverages.

### BACKGROUND

In the recent times, there has been a significant growth in number of food and beverage service outlets. In the food and beverage service outlets, communications and operations that occur with customer transactions involve verbal communication and repetitive manual labor. This requires a service location to utilize a large physical space. The combination of high labor costs and location rent costs pose two issues. Firstly, a sustainable business is not possible in most locations due to an imbalance in cost to revenue generated. Secondly, a high traffic, busy location results in a poor customer experience due to the efficiency constraints of the above mentioned method. In the food and beverage serving outlets, the order placing staff communicates verbally with the customers for placing orders desired by the customers and further informs the order preparing staff to prepare the orders. Many a times, there is lack of coordination amongst the order placing staff and the order preparing thereby resulting in mismatch of the order placed with those that are served. Further, due to lack in effective tracking of the orders, the orders are not being served as per the first come first serve basis. Additionally, the customers are not provided with customized options for customizing the order.

Therefore, in view of the above, there is a need for a system that is significantly lower cost, higher efficiency yet allows for the production of premium, personalized beverages. Further, there is need for a system such as that automates food and beverages services that can lead to significant increase in productivity.

### SUMMARY

This summary is provided to introduce concepts related to systems and methods for serving one or more items and the concepts are further described below in the detailed description. This summary is not intended to identify essential features of the claimed subject matter nor is it intended for use in determining or limiting the scope of the claimed subject matter.

In an implementation, a system for serving one or more items is described. The system may comprise a central controller coupled to a memory storing programmed instructions capable of being executed by the central controller. In an aspect, the central controller may execute a programmed instruction to capture order details associated to an order placed by a user for serving an item. The system may further comprise a control system electronically coupled with the central controller. The control system, in response to one or more programmed instructions executed by the central controller, may be configured to trigger one or more item producing components along with a robot unit (hereinafter also referred as robotic arm interchangeably) to collectively process the order in order to produce the item based upon the order details associated to the order. Further, the control system may be configured to determine a hold zone position available from multiple hold zone positions in a predefined hold zone for holding the item corresponding to the order processed. The robot unit of the said system, in response to instructions received from the control system, may be configured to move the item produced corresponding to the order in the said hold zone position of the hold zone. The robot unit may further dispense the item from the said hold zone position into a delivery bay engine of a plurality of delivery bay engines thereby serving the item to the user.

In another implementation, a method for serving one or more items is described. The method may comprise capturing, via a central controller, order details associated to an order placed by a user for serving an item. The method may further comprise triggering, via a control system electronically coupled with the central controller, one or more item producing components along with a robot unit to collectively process the order in order to produce the item based upon the order details associated to the order. Further, the method may comprise determining, via the control system, a hold zone position available from multiple hold zone positions in a predefined hold zone for holding the item corresponding to the order processed. The method may further comprise moving, via the robot unit, the item produced corresponding to the order in the said hold zone position of the hold zone. Furthermore, the method may comprise dispensing, via the robot unit, the item from the said hold zone position into a delivery bay engine of a plurality of delivery bay engines thereby serving the item to the user.

In accordance with aspects of the aforementioned implementations, the said order may be placed by the user, via a user device of the user, to a server communicatively coupled with the said central controller. The order placed is confirmed based upon successful processing of payment via a payment engine coupled to the server. The server may be configured to store the order details comprising at least a unique order identifier, the item selected, an item identifier, a pick-up time, customized options selected by the user for producing the item and payment details. The item corresponding to the order is produced prior to expiry of the pick-up time based upon the customized options selected by the user. Further, the one or more components, producing the order in co-ordination with the robot unit, may comprise at least one of an item maker, a container dispenser and an ingredient dispenser. The hold zone position available is either a hold zone position free from any order or a hold zone position holding a previous order for a longest time as compared to other hold zone positions in the hold zone. The control system may instruct the robot unit to dispose the previous order held in the hold zone position thereby making the hold zone position available for holding the said order. The control system may record the hold zone position available in the hold zone and thereby associate the hold zone position recorded to the said order. The robot may dispense the item by rotating the said delivery bay engine in the direction of the user and opening the door of the said delivery bay engine in order to provide the item available for pick-up by the user. The control system may, via the server, notify on the user device a status indicative of initiation of the processing of the order, current stage of the processing of the order and successful completion of the processing of the order, wherein based upon the successful completion of the processing of the order, the user is notified regarding the availability of the item for pick-up at the said delivery bay engine. The said delivery bay engine of the plurality of delivery bay engines may be selected for dispensing of the order based upon receipt of an input order identifier from the user on a display device of the said delivery bay engine. Further, the order is dispensed after the matching of the input order identifier with the order identifier contained in the order details associated to the said order.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1A illustrates a network implementation of system 100 enabling automated serving of one or more items to a user, in accordance with an embodiment of the present subject matter.

FIG. 1B illustrates a typical mechatronics system architecture 100′, in accordance with an embodiment of the present subject matter.

FIG. 2 illustrates a block diagram 200 showing components of the system 100, in accordance with an embodiment of the present subject matter.

FIG. 3 illustrates a flow diagram 300 depicting steps performed by the system 100, in accordance with an embodiment of the present subject matter.

FIG. 4 illustrates a flow diagram 400 showing workflow for registration of the user with the server 100, in accordance with an embodiment of the present subject matter.

FIG. 5 illustrates a flow diagram 500 showing workflow for placing of an order by the user, in accordance with an embodiment of the present subject matter.

FIG. 6 is a flow diagram 600 showing workflow for making a payment corresponding to the order placed by the user, in accordance with an embodiment of the present subject matter.

FIG. 7A and FIG. 7B illustrates a flow diagram 700 showing workflow for execution/processing of the order, in accordance with an embodiment of the present subject matter.

FIGS. 8A, 8B, 8C and 8D illustrates a block diagram 800 illustrating the components of the automated food and beverage serving system along with a hold zone and various hold zone positions of the said hold zone, in accordance with an embodiment of the present subject matter.

FIG. 9 is a flow diagram showing workflow 900 for cancelling the order by the user, in accordance with an embodiment of the present subject matter.

FIG. 10 illustrates a method 1000 for automated serving of one or more items to a user, in accordance with an embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

System(s) and method(s) for automated serving of the one or more items are described. In accordance with aspects of the present disclosure, core of the system is a central controller adapted to receive customer orders and related data via an internet connection. The customer orders and the related data is then distributed by the central controller to a control system, various other sub-controllers and Programmable Logic Controllers (PLCs) within the automated food and beverage serving system that controls multiple components involved in the order processing, production queuing, food and beverage production, quality validation, delivery and maintenance of the system. The central controller is built on a framework comprising different independent engines configured to operate autonomously and concurrently. This simplifies maintenance and servicing procedure thereby significantly reducing labor cost.

In accordance with embodiments of the present disclosure, the system may employ a modular layered software architecture to optimize operations and maintenance at large scale. The system may be constructed of multiple software engines that serve as building blocks. Each engine is responsible for a particular job, wherein each engine further comprises metadata models used to transform the data into a different state. This highly scalable approach enables the possibility of incremental fine-tuning of each software engine for optimized long-term performance and reliability. In an aspect, the customer orders, management controls and system telemetry are communicated between the central controller of the system and a back end server (also referred hereinafter as server interchangeably) through a network connection. Customers may use desktop computer, web-based and/or mobile-based software to place orders, locate locations of nearby food and beverage serving system, process payments and other relevant actions related to using the automated food and beverage serving system.

While aspects of described system and method for automated serving of one or more items to a user may be implemented in any number of different computing systems, environments, and/or configurations, the embodiments are described in the context of the following exemplary system.

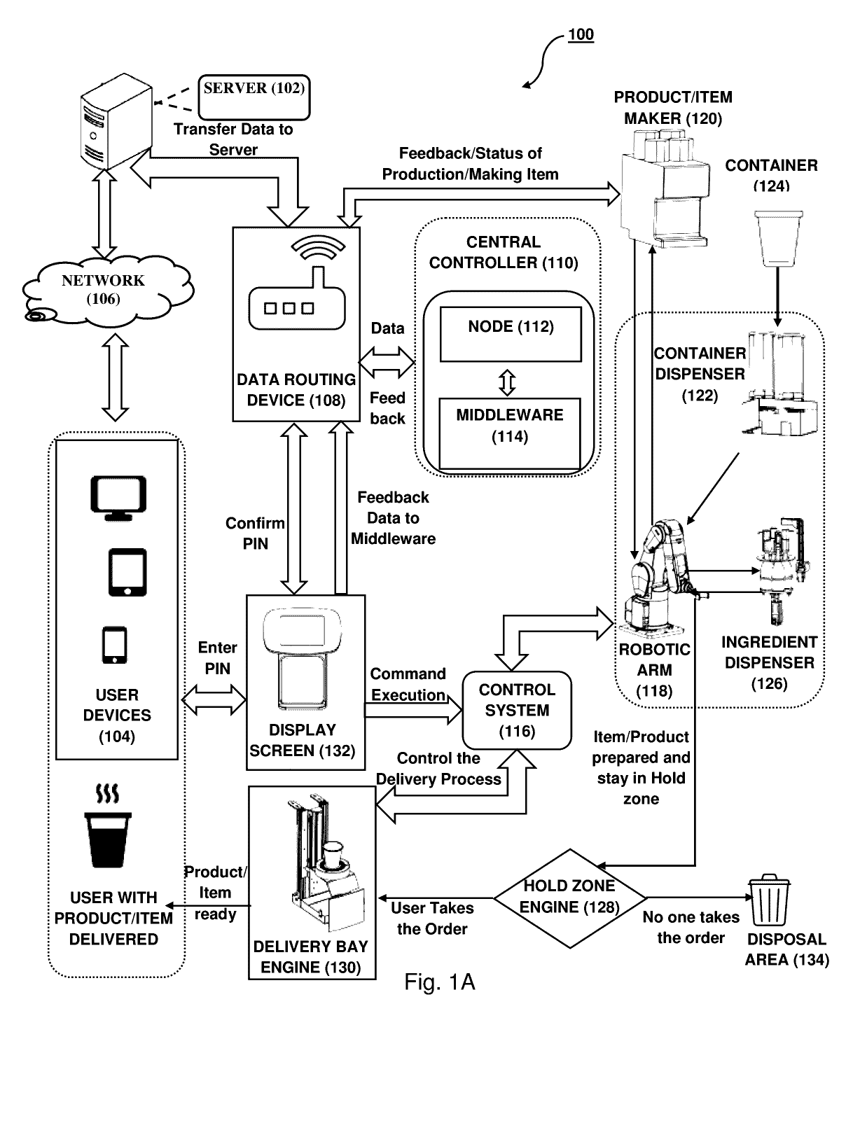

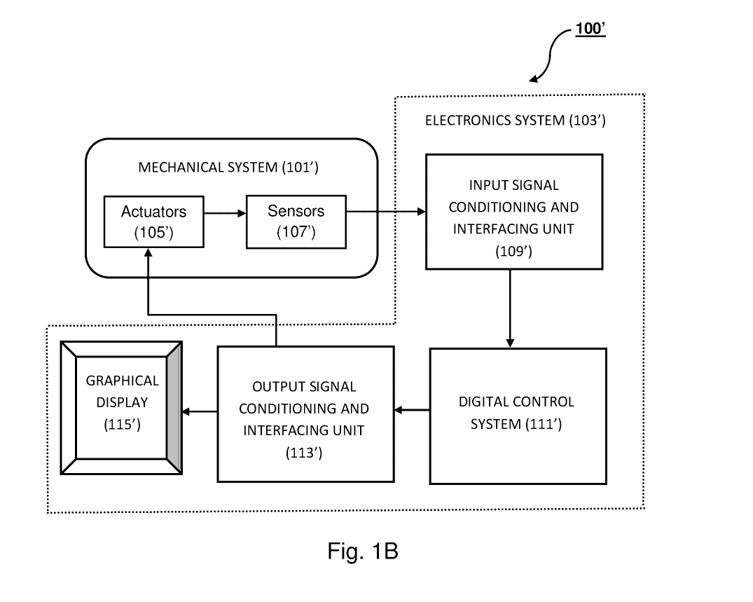

Referring now to FIG. 1A, a network implementation of a system 100 for enabling automated serving of one or more items to a user is illustrated, in accordance with an embodiment of the present subject matter. As shown in FIG. 1A, the system 100 may comprise a server 102 communicatively coupled with one or more user devices 104 via a network 106. In one embodiment, the server 102 is a cloud server. It will be understood that the system 100 may be accessed by multiple users through the one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the server 102 through the network 106.

In one implementation, the network 106 may be a wireless network, a wired network or a combination thereof. The network 106 can be implemented as one of the different types of networks, such as intranet, local area network (LAN), wide area network (WAN), the the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. Computing devices and networks also may support wireless wide area network (WWAN) communications services including Internet access such as EV-DO, EV-DV, CDMA/1xRTT, GSM/GPRS, EDGE, HSDPA, HSUPA, and others. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

The server 102 may include at least one processor, an input/output (I/O) interface and a memory (not shown in FIG. 1A). The at least one processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory.

The I/O interface may include a variety of software and hardware interfaces, for example, a web interface, a graphical user interface, and the like. The I/O interface may allow the server 102 to interact with a user directly or through the user devices 104. Further, the I/O interface may enable the system server 102 to communicate with other computing devices, such as web servers and external data servers (not shown). The I/O interface can facilitate multiple communications within a wide variety of networks and protocol types, including wired networks, for example, LAN, cable, etc., and wireless networks, such as WLAN, cellular, or satellite. The I/O interface may include one or more ports for connecting a number of devices to one another or to another server.

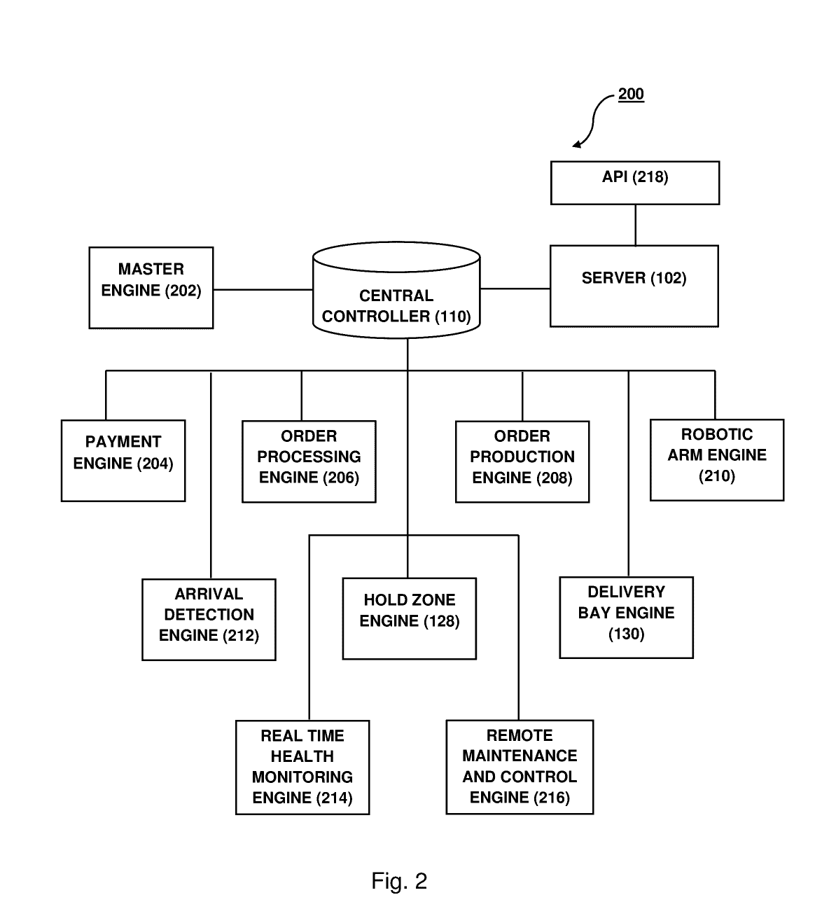

The memory may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory may include modules and data. The modules include routines, programs, objects, components, data structures, etc., which perform particular tasks or implement particular abstract data types. The data, amongst other things, serves as a repository for storing data processed, received, and generated by one or more of the modules. The server 102 may further comprise an application programming interface (API) 218, shown in FIG. 2, providing a programmatic interface to a defined request-response message system, expressed in JavaScript Object Notation JSON. The JSON is an open standard format that uses human-readable text to transmit data objects consisting of attribute-value pairs.

The server 102 may further be communicatively coupled with a central controller 110. The central controller 110 may be implemented as one or more microprocessors, microcomputers, microcontrollers, digital signal processors, central processing units, state machines, logic circuitries, and/or any devices that manipulate signals based on operational instructions. Among other capabilities, the central controller 110 is configured to fetch and execute computer-readable instructions stored in the master engine 202 as shown in FIG. 2, wherein the master engine 202 is a central module which co-ordinates with all other engines and/or components, manages the program flow, synchronizes processes and handles errors. The central controller 110 executes computer-readable instructions in order to instruct a control system 116 shown in FIG. 1A to perform one or more tasks for processing of the orders.

Referring to FIG. 1A, the control system 116 in turn, in response to instructions executed by the central controller 110, is capable of controlling one or more components comprising a robotic arm 118 (also referred as robot unit 118 interchangeably), a product/item maker 120, a container dispenser 122, a container 124 capable of being dispensed via the container dispenser 122, an ingredient dispenser 126, a hold zone engine 128, a delivery bay engine 130 having a display screen 132. In one example, the product/item maker 120 may be a coffee maker or a hot cake maker, and the like depending on the food/beverage that is required to be prepared. Further, it must be noted that the central controller 110, the control system 116, the robotic arm 118, the product/item maker 120, the container dispenser 122, the ingredient dispenser 126, the hold zone engine 128, the delivery bay engine 130 and the display screen 132 collectively forms an automated product/item serving system (hereinafter also referred as automated food and beverage serving system) of the system 100.

It must be understood that the automated food and beverage serving system may be implemented as a mechatronics system architecture. FIG. 1B illustrates a typical mechatronics system architecture 100′. As shown in FIG. 1B, the mechatronics system architecture 100′ may comprise a mechanical system 101′ and an electronics system 103′. The mechanical system 101′ may further comprise actuators 105′ and sensors 107′. The actuators 105′ may comprise solenoids, voice coils, DC motors, stepper motors, servo motors, hydraulics, pneumatics, and the like. In accordance with the aspects of the present disclosure, the aforementioned actuators 105′ may belong to components, of the system 100, comprising at least one of the robotic arm 118, the product/item maker 120, the container dispenser 122, the ingredient dispenser 126, the hold zone engine 128, and the delivery bay engine 130 (shown in FIG. 1A). The actuators may be configured to move and/or control each of these components for enabling the serving the one or more items to the user. It is to be noted that each of the actuators 105′ may receive a control signal from the digital control system 111′ via the output signal conditioning and interfacing unit 113′. The control signal indicates an energy signal that is converted into a mechanical motion by an actuator in order to move and/or control at least one of the aforementioned components.

Further, referring FIG. 1B, the said mechanical system may further comprise the sensors 107′ capable of sensing/measuring variety of physical variables. The sensors 107′ may comprise switches, potentiometer, photoelectric sensor, digital encoder, a strain gauge, thermocouple, an accelerometer, microelectronic (MEMs) sensor, and the like. At least one of the sensors 107′ may be configured to sense/measure at least one physical variable, including but not limited to, a level/displacement, tilt/direction, sound, light, stress, pressure, and the like and transmit a sensed signal to the digital control system 111′ via the input signal conditioning and interfacing unit 109′ as shown in FIG. 1B. The input signal conditioning and interfacing unit 109′ may receive the sensed signal from the sensors 107′ and performs signal conditioning and processing of the said sensed signal. In the signal conditioning step, the sensed signal may be amplified and filtered via an amplifier and a filter present within the input signal conditioning and interfacing unit 109′ in order to obtain a conditioned signal suitable for further processing. In the processing step, the conditioned signal is processed via an analog-to-digital converter or a digital-to-analog converter in order to convert the conditioned signal into digital/analog signal, as the case may be as per requirements, to obtain a processed sensed signal (either analog/digital processed sensed signal) to be inputted to the digital control system 111′ for further processing.

As shown in FIG. 1B, the digital control system 111′ acts as a system controller and may be implemented as a digital computer and/or desktop computer. The digital control system 111′ may comprise different logic circuits, microcontrollers, control algorithms, programmable logic controllers (PLCs), application-specific integrated circuits (ASICs), digital signal processors (DSPs), etc. In accordance with aspects of the present disclosure, the control system 116 as shown in FIG. 1A refers to a digital control system 111′. The digital control system 111′ based upon the execution of at least one of the control algorithms is capable of using the processed sensed signal to compute control actions to be applied by at least one of the actuators 105′ as shown in FIG. 1B. The digital control system 111′ passes a control signal to the at least one of the actuators 105′ via the output signal conditioning and interfacing unit 113′.

As shown in FIG. 1B, the output signal conditioning and interfacing unit 113′ processes the control signal received from the digital control system 111′ using power amplifiers, pulse width modulation (PWM) control units, and power transistors present within the output signal conditioning and interfacing unit 113′ and convert the processed control signal into an analog/digital control signal via digital-to-analog converter or an analog-to-digital converter, as the case may be as per the requirements. Further, the output signal conditioning and interfacing unit 113′ may transmit the analog/digital control signal to the at least one of the actuators 105′ in order to process the analog/digital control signal and thereby move and/or control at least one of the aforementioned components including the robotic arm 118, the product/item maker 120, the container dispenser 122, the ingredient dispenser 126, the hold zone engine 128, and the delivery bay engine 130 (shown in FIG. 1A).

It is to be further noted that the digital control system 111′ acts a feedback system between the actuators 105′ and the sensors 107′. In one example, a motion signal from one of the actuators 105′ may be sensed by one of the sensors 107′ and transmitted to the digital control system 111′ via the input signal conditioning and interfacing unit 109′. The digital control system 111′ may compare the motion signal with reference motion signal to correct an error (if any) and provide response in form of a correct control signal to the actuator in order to obtain a desired actuator output. Therefore, a closed loop control system exists between the actuators 105′ and the sensors 107′ in form of the digital control system 111′ that enables accuracy in the movement and/or control of aforementioned components. Further, the graphical display 115′ (shown in FIG. 1B) may be configured to display and/or visualize information to the end users as-well-as facilitate interaction of the system components with the end users. In accordance with embodiments of the present disclosure, the user devices 104 and the display screen 132 may indicate the graphical display 115′ of the mechatronics system architecture 100′. Particularly, in various embodiments, the user devices 104 and the display screen 132 may display information/data to the end users through the Ethernet module and/or Ethernet cable, wherein the Ethernet module and/or Ethernet cable herein indicates the output signal conditioning and interfacing unit (113′) of the mechatronics system architecture 100′ shown in FIG. 1B. In an embodiment, an internal touch panel may be provided for maintenance of the automated food and beverage serving system, wherein such. internal touch panel may further act as the graphical display 115′. It is to be noted that the internal touch panel could mirror all data control the automated food and beverage system has or provides logical control units that could be interacted with, e.g. control robot arm from point of one of the positions in the hold zone area to the disposal region. In this manner, the entire method of automated serving of items via the components of the system 100 is controlled through the digital control system (i.e. the control system 116 shown in FIG. 1A).

It must be noted that though FIG. 1A illustrates a single delivery bay engine, a single product/item maker, a single ingredient dispenser, however, the automated food and beverage serving system may comprise multiple delivery bay engines (each having separate display screen), multiple product/item makers, multiple container dispensers, multiple containers and multiple ingredient dispensers.

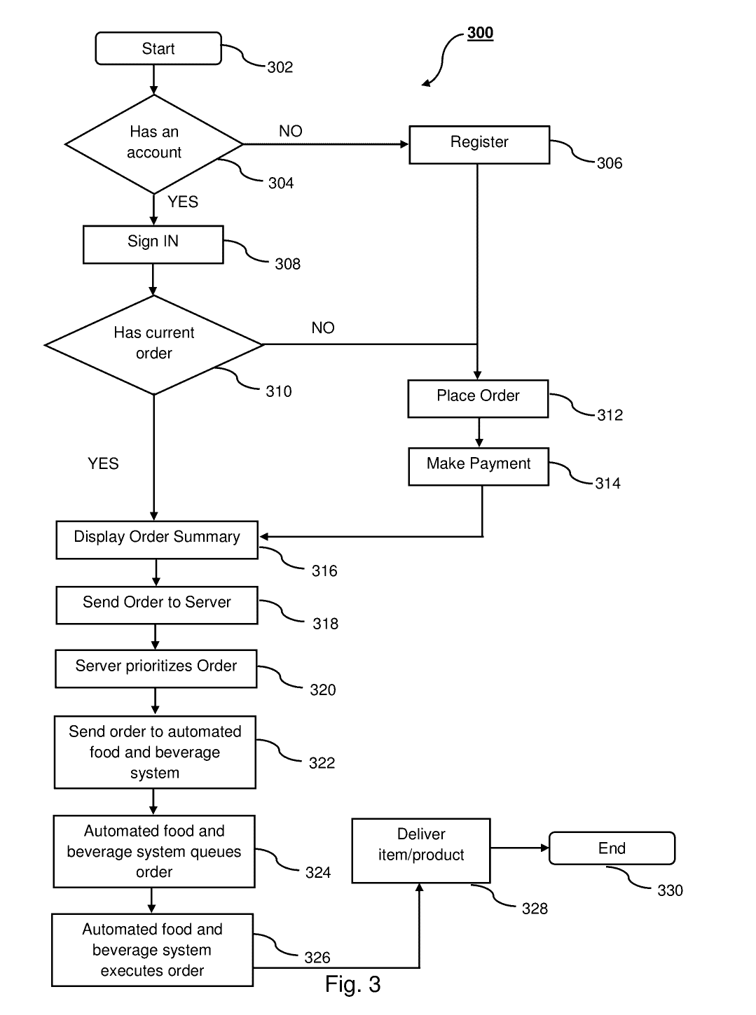

The central controller 110 may be configured to share data with the server 102 and vice-versa via a data routing device 108 shown in FIG. 1A. In one example, the data routing device 108 may include at least one of a router, a bridges, a gateway, a firewall, a switch or a combination thereof. The central controller 110 may be configured to convert the data/information received from the server 102 into machine understandable instructions/format desired for the automated food and beverage system to perform the tasks of preparing the item/product and delivery of the said item/product to the user. The detail description of the order placement, the order processing and the delivery of the order is further explained referring to FIG. 3 to FIG. 10 as below. It is to be noted that in the description of FIG. 3 to FIG. 10, wherever applicable, the description of each component (i.e. the server 102, the user device 104, the central controller 110, the node 112, the middleware 114, the control system 116, the robotic arm 118, the product/item maker 120, the container dispenser 122, the container 124, the ingredient dispenser 126, the hold zone engine 128, the delivery bay engine 130 and the display screen 132 of the delivery bay engine 130) is explained by referring these components as shown in FIG. 1A.

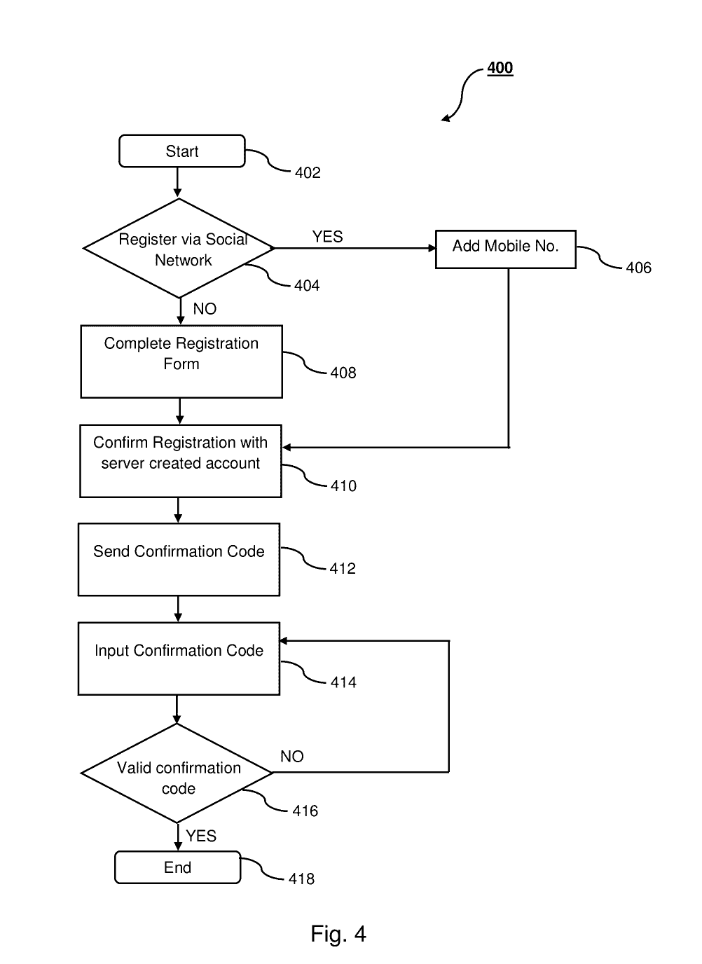

Referring the FIG. 3 is a flow diagram 300 depicting steps performed by the system 100 to facilitate and/or enable automated serving of one or more items/products (hereinafter referred as menu items) to the user. As shown in FIG. 3, the method for automated serving of menu items is initiated at block 302. At block 304, a software application (hereinafter referred to as a “device app”) present within the user device 104 may check whether the user has an account registered with the device app. If the user does not have the account registered with the device app, then at block 306, the device app may prompt the user to register with the device app. The details of the registration are explained referring to FIG. 4.

Referring to FIG. 4, the workflow for registration of the user is illustrated. As shown, at block 402, the registration process is initiated. At block 404, the user is prompted, by the device app, on the user device 104 to register with the device app via a social networking account of the user. At block 406, if the user registers via the social networking account, the user is prompted to provide mobile number/contact number. If the user does not have a social networking account or denies logging in via the social networking account, the user may be instructed, by the device app, to complete the registration form at block 408. At block 410, the registration of the user is confirmed by the device app and user server account may be created. At block 412, a confirmation code indicative of successful registration is sent on the user device 104. At block 414, the user is prompted, by the device app, on the user device 104 to input the confirmation code. At block 416, the validity of the confirmation code entered by the user is checked by the device app in order to complete the user registration process. Based upon successful validation of the confirmation code, the registration of the user is completed thereby terminating the registration workflow at block 418.

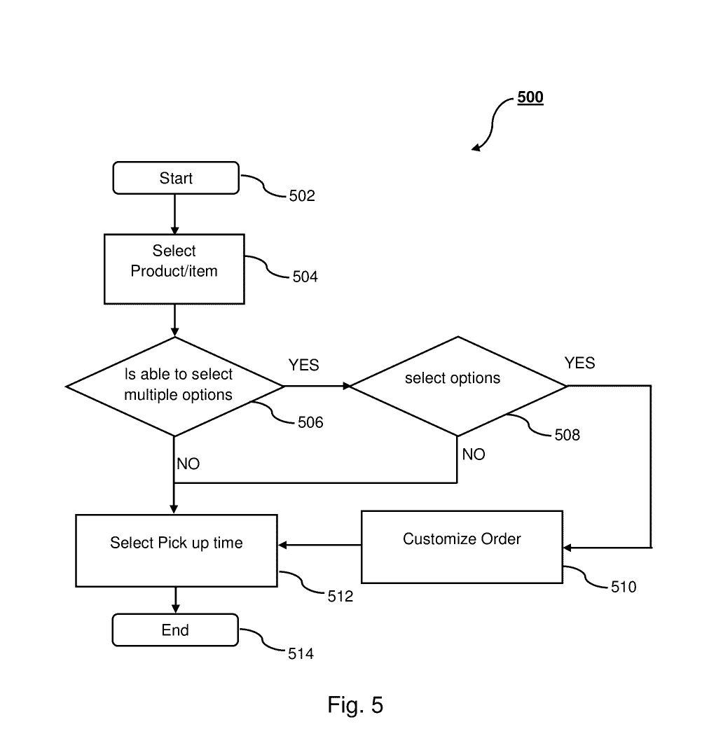

Now, again referring to FIG. 3, after successful logging of the user into the device app at block 308, then at block 310, the device app checks whether the user has placed a current order for a menu item with the server 102. If it is determined at block 310 that there is no current order being placed by the user, then at block 312, the device app prompts the user on the user device 104 to place an order for any item/product. The details of placing an order by the user via the device app are explained referring to FIG. 5.

Referring to FIG. 5, the workflow for placing an order by the user is illustrated. As shown, at block 502, the order placement process is initiated. At block 504, the user may be prompted on the user device 104 by the device app to select a menu item from a plurality of menu items categorically displayed on display screen of the user device 104. Further, corresponding to each menu item, availability status for the said menu item may be displayed to the user in real time. At block 506, the device app may check availability of customized options for the preparation/making of the said menu item selected by the user. If the customized options are available, then at block 508, the user is prompted to select one of the customized options of his/her interest in order to customize the order being placed by the user. If the customized options are selected by the user, a customized order corresponding to the user is generated at block 510. At block 512, irrespective of the customized options selected by the user, the user is prompted to select a pickup time for the order placed by the user. In some embodiments, the user may be displayed with earliest pickup time and additional pickup time intervals suggested by the server, for an instance, 5 to 15 minutes later after the earliest pickup time and the like to be selected by the user. The order placement process is then terminated at block 514 based upon selection of appropriate pickup time by the user.

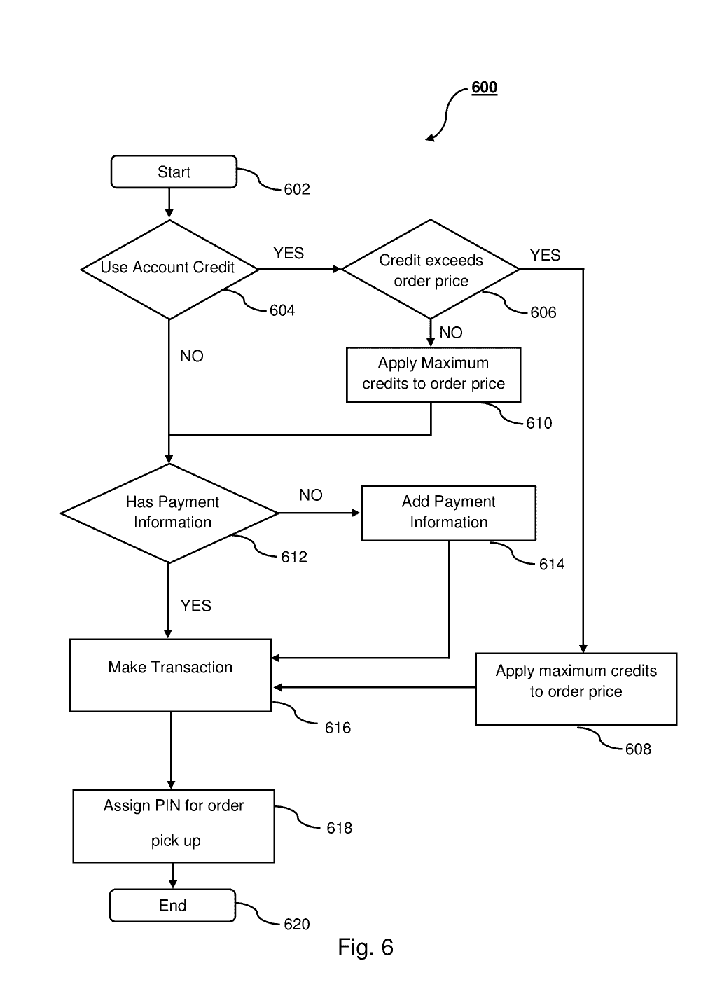

Now, again referring to FIG. 3, once the order is successfully placed, then at block 314, the user is prompted by the device app to make payment corresponding to the order placed. The details of making a payment corresponding to the order placed by the user are explained referring to FIG. 6.

Referring to FIG. 6, the workflow for making a payment corresponding to the order placed by the user is illustrated. As shown, at block 602, the process for making a payment for the order placed is initiated. The device app within the user device 104 may prompt the user to process the payment for the order based associated with the user. At block 604, the user is prompted to select account credit for processing the payment. If it is determined at block 604 that the user has selected the account credit for the processing of the payment, then at block 606, the device app determines whether the credit amount in the account credit exceeds the order price. If is determined at block 606 that the account credit amount exceeds the order price, then at block 608, the device app applies maximum credits to the order price by subtracting the account credit applied to the total order price. Specifically, when the user applies account credit to the order, total account credit amount is subtracted with the corresponding amount, thereby completing the transaction at block 616. If it is determined at block 606 that the account credit amount is less than the order price, then at block 610, the device app applies maximum credits to the order price by subtracting full credit amount available for the user account to reduce the total order price that is outstanding for payment.

At block 612, the device app may check whether the user account have payment information for paying the remaining outstanding amount. At block 612, if it is determined that the user account has the payment information, the device app enables the user to complete the transaction at block 616 using such payment information and thereafter confirm the payment made. At block 612, if it is determined that the user account does not have payment information, then at block 614, the user may be prompted to add payment information in the device app. In an embodiment, the user is prompted to add the payment information to the user account for payment of the current order as-well-as future orders. There are various types of payment methods such as credit card payment, debit card payment, internet banking, wallet, PayPal and the like. In one example, in order to add credit card payment information, the user must enter a credit card number, credit card expiration date and a credit card security code.

The device app may further enable the user to complete the transaction at block 616 using the payment information added in order to process the current order and thereafter confirming the payment made. In an embodiment, the transaction is processed by the user via the payment engine 204 shown in FIG. 2. The payment engine 204 may use existing payment application programming interfaces (e.g. a Braintree API) and third-party pre-authorized payments systems (e.g. PayPal) in order to process the payment.

Referring FIG. 6, at block 618, a unique order identifier (Order ID) in form of order pickup PIN may be assigned corresponding to the order placed by the user. The user may use the order pickup PIN to pick up the order at the automated food and beverage serving system. The user must enter the said PIN on the touch screen of the delivery bay engine at the automated food and beverage serving system to identify themselves and pickup their order.

Now, again referring to FIG. 3, once the payment is successfully made, then at block 316, the device app within the user device 104 may display an order summary associated with the order to the user on the display screen of the user device at. The order summary may capture the order details, associated to the order, including the menu item selected, the customized options selected, payment method used, pickup time and the PIN that is used for order pickup at the automated food and beverage serving system. At block 318, the order and the order details associated therewith are transferred to the server 102 for further processing of the order. At block 320, the server 102 may reformat the order and linked the said order to a Recipe ID. Further, the server 102 may prioritize the order based on current status of the automated food and beverage serving system. In an embodiment, the server 102 may match the Order ID, associated to the order placed by the user, with the Recipe ID to efficiently store and send data.

It must be noted that the server 102 is configured to maintain multiple queues for different orders at a different delivery time. The server 102 therefore places the current order into these queues according to the delivery time assigned to the user placing the order. It is to be noted that the server 102 is enabled to assign the priority to each order or queues the order by applying “first in, first out” (FIFO) policy. The automated food and beverage system is capable of serving a wide range of products requiring different production time and different components for preparing such wide range of products. The server 102 may be capable of accepting the order at a later time (e.g. 10 minutes later). It is to be noted that since the server 102 is aware about the status of the automated food and beverage system, and the production time of each order, the server 102 is capable of calculating the earliest available time slot for the respective user. In one example, if the user is ordering a menu item namely “Caffe Latte” and has requested to receive the order at the earliest, however, since there are still ten cups of beverage in the queue, the server 102 will then accordingly notify the user about probable time of delivery of the “Caffe Latte” to the user.

It must be further understood that some nature of products/items may be produced only by certain item/product maker and hence the order by one item/product maker should not be blocked by the other item/product maker irrespective of the priority of these items in the queue. In one example, if there is a Hotcake Maker and a Coffee Maker acting independently as product/item maker 120 in the automated food and beverage system, the user who orders a hot cake will not be blocked by the other users who have ordered latte. However, if there is exception (e.g. one of the Beverage Makers becomes failure when making a drink), the affected order will be remade in the correct order. In an example, consider there are two coffee makers (CM1, CM2) and one hot cake maker (HM1), whereas there are ten coffee orders (CO1, CO2, . . . CO10) and three hot cake orders (HCO1, HCO2, HCO3). In this example, assume these orders are assigned to the respective coffee maker(s) and hot cake maker(s) as below:

CM1: CO1→CO3→CO5→CO7→CO9

CM2: CO2→CO4→CO6→CO8→CO10

HM1: HCO1→HCO2→HCO3

In the above example, assume that while the CM2 is making CO4 and CM2 is failed due technical reasons or otherwise. At the same time, assume that CM1 is making CO3, in such scenario all the remaining orders (including CO4) will be reassigned to CM1 based on the priority as below:

CM1: CO1→CO3→CO4→CO5→CO6→CO7→CO8→CO9→C010

CM2: CO2→FAILURE

HM1: HCO1→HCO2→HCO3

It must be noted that the above reassignment does not affect the hot cake maker since the hot cake maker in any case is unable to produce coffee. If both the coffee makers are failed, the remaining order will be marked as FAILED and reported to the server 102 by the central controller 110. Further, as-soon-as the coffee maker is failed, a signal will be transmitted by the central controller to the server 102 in order to enable the server 102 to adjust the prediction of the user's waiting time.

Now again referring to FIG. 3, after the order is queued by the server 102, at block 322, the server 102 may transmit the order along with the order details to the automated food and beverage serving system. The order queue processed by the server 102 is sent to the automated food and beverage serving system. Specifically, the order along with the order details is routed from the server 102 to the central controller 110 via the routing device 108 as shown in FIG. 1A.

At block 324, the automated food and beverage system queues the order. More particularly, the automated food and beverage system may reset the priority of the received order based upon current state of the automated food and beverage serving system. Therefore, the automated food and beverage serving system carries out a second priority setting procedure. Further, the automated food and beverage serving system allocates orders to available components inside the food and beverage serving system to execute an order production.

In an embodiment, the automated food and beverage system serves the order processed to the user with the help of an order processing engine 206 shown in FIG. 2. The order processing engine 206 executes AI based algorithm in order to serve multiple orders in the most efficient manner. The order processing engine 206 may distribute the orders in a manner such that the automated food and beverage serving system is enabled to prepare the orders in advance with exact timing thereby reducing or avoiding any wait time during pickup.

In an embodiment, the order processing engine 206 serves the order based on “Arrival first-served policy” or “Early-pickup first-served policy”. According to the “Arrival first-served policy”, the menu item is first served, by the order processing engine 206, to the user who has placed an order and is in close proximity of the said automated food and beverage serving system. Whereas according to the Early-pickup first-served policy”, the order processing engine 206 may employ a fair scheduling method to serve the users based on the order pickup times of the users. The arrival of the user may be determined using an arrival detection engine 212 as shown in FIG. 2. The arrival detection engine 212 comprises a combination of hardware and software module to detect the arrival of the user within the reach of the automated food and beverage serving system. In an embodiment, the arrival detection engine 212 may use custom designed Bluetooth low energy (BLE) technology to effectively process customer orders in advance so that waiting time is eliminated and production capability is maximized. The arrival detection engine 212 may generate an “Arrival” event once a user who has placed an order is in the close proximity to the automated food and beverage serving system.

Now again referring to FIG. 3, at block 326, the automated food and beverage serving system may execute/process the order of the user using the allocated components. It must be understood that central controller 110 is a computer system present within the automated food and beverage serving system that converts the information/data received from the server 102 to machine understandable instructions. The data/information received by the automated food and beverage serving system, from the server 102, comprises the order placed by the user along with the order details associated to the order. More particularly, the order details herein refer to what the user has ordered and arrival time of the user for collecting the order from the delivery bay engine 130. The data/information is extracted and analyzed by the central controller 110 and passed to the control system 116 and other components of the automated food and beverage serving system in form of instructions.

In one example, if the user via the user device 104 has placed an order for an item “Vanilla Latte” and the user arrival time of the user for picking up the “Vanilla Latte” ordered is 20 minutes later, the order details including the item ordered (i.e. “Vanilla Latte”) and the arrival time (i.e. 20 minutes) is transferred to the central controller 110 via the server 102. Based upon the order details received, the central controller 110 may extract the product information, i.e. “Vanilla Latte”. However, the control system 116 and the product/item maker 120 may not be able to understand the meaning of the “Vanilla Latte”. The central controller 110 may be configured to instruct the product/item maker 120 to prepare one of the recipes predefined in the product/item maker 120 to complete the order for the item “Vanilla Latte”. Similarly, the central controller 110 may be configured to instruct the control system 116 the manner/way in which the order is to be completed.

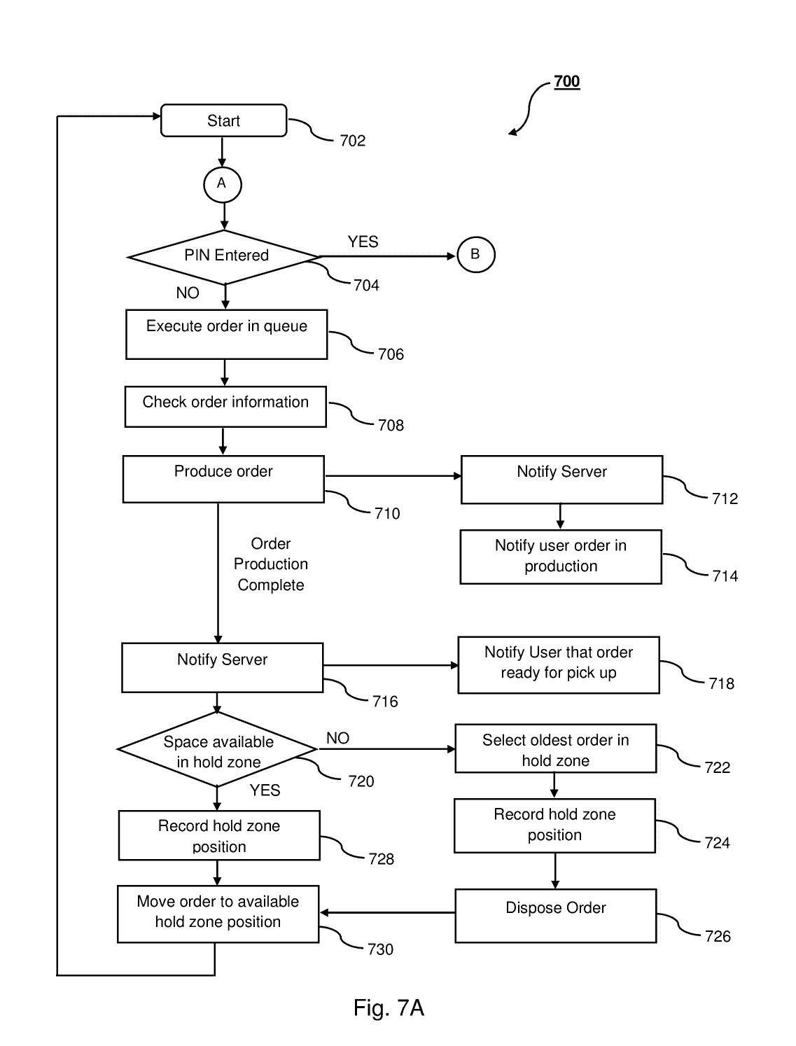

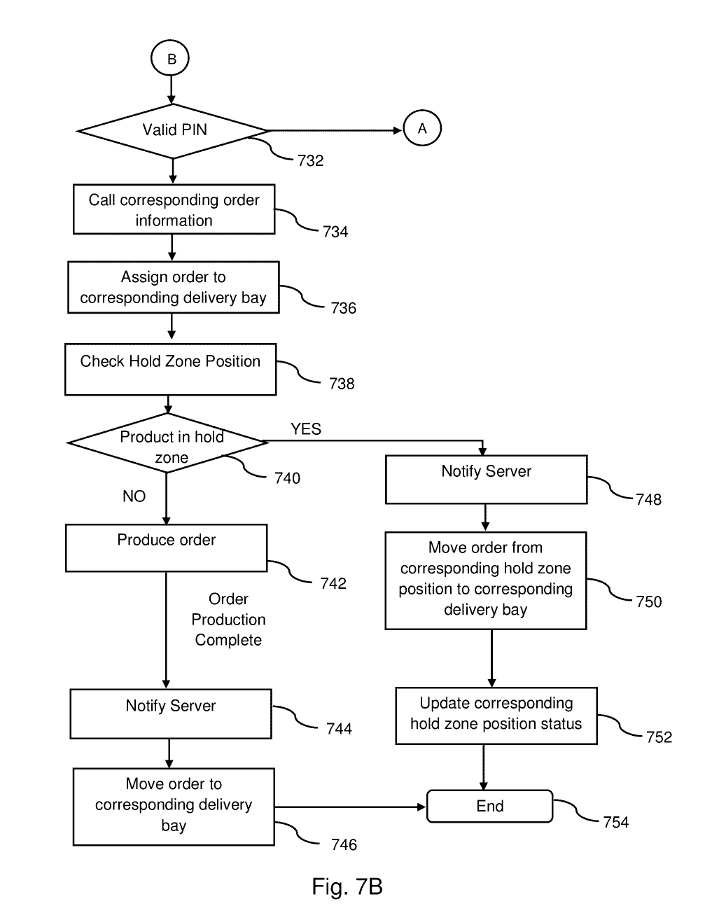

Therefore, the entire business logics for instructing the control system 116 and the other components are implemented within the central controller 110. The business logics herein refer to predefined business rules that have to be applied to the orders. For instance, in the aforementioned example, it makes no sense for the Beverage Maker to start making the drink immediately. Instead, the central controller 110 put the request in a queue and only passes the instruction to the control system 116 and other sub-controller at the right time, so that the user will collect the beverage that comes with the best quality. The central controller 110 may further comprise a node 112 and a middleware 114. The node 112 acts as a sub-controller configured to perform data analysis of the data and control various functions of the automated food and beverage serving system. Whereas the middleware 114 is a sub-controller that is configured to translate the data collected and transmit the translated data to the node and control the functions of the control system 116.The details of processing/execution of the order are explained referring to FIG. 7A and FIG. 7B.

Referring to FIG. 7A, at block 702, the process for execution of the order is initiated. In an embodiment, the process is executed under the control of the control system 116 based on instructions received from the central controller 110. At block 704, the control system 116 may check whether the user has entered the PIN corresponding to the order on the display screen 132 of one of the delivery bay engine(s) 130. The display screen 132 may be a capacitive touch enabled display screen showing a user interface for the user to enter the PIN and read relevant information. It is possible for multiple users to use different delivery bay engine touch screens concurrently. If there are more users than the delivery bay engines available, some users must wait until a delivery bay engine touch screen is available.

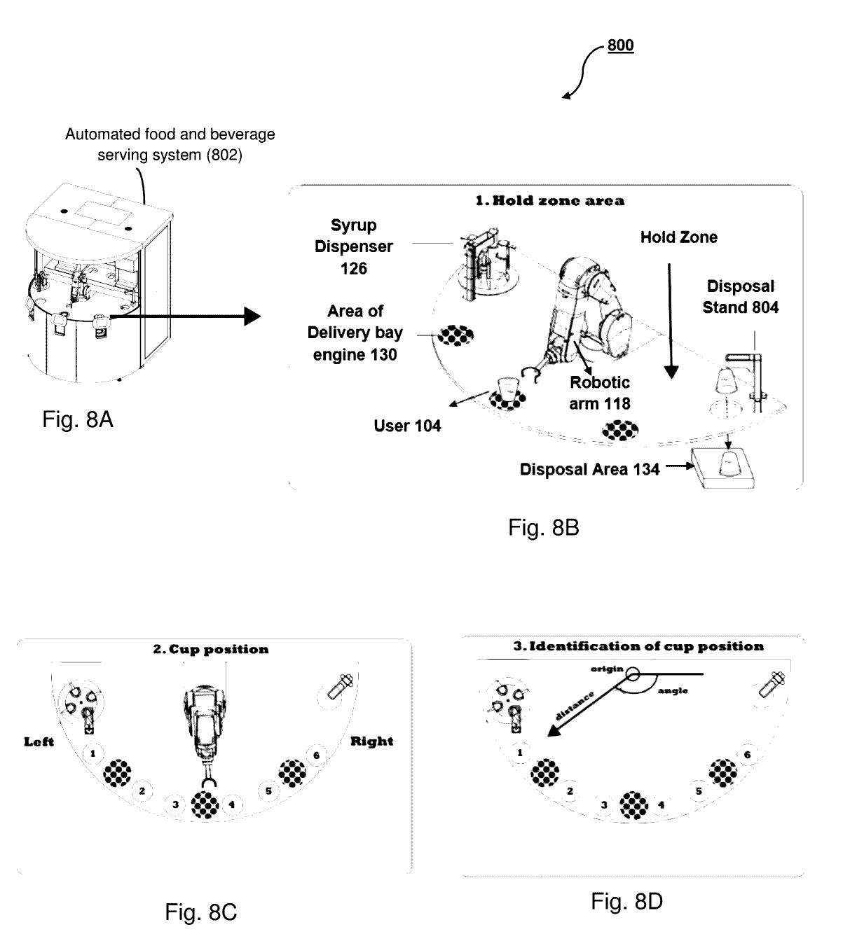

If it is determined at block 704 that the user has entered the PIN on the display screen 132 of the delivery bay engine 130, then the process proceeds to block 732 shown in FIG. 7B. As shown, at block 732, the control system 116 may check whether the PIN entered is a valid PIN. Based upon the validation of the PIN, at block 734, the control system 116 may retrieve order details/information corresponding to the order from the server 102 via the central controller 110. At block 736, the delivery bay engine 130 corresponding to the display screen on which the PIN is entered is assigned for the delivery of the order of the user. At block 738, a hold zone position, in the hold zone, for the order is checked using the hold zone engine 128. The hold zone is a slot where the menu item may be placed and ready for pickup. The hold zone engine 128 is configured to identify and notify the automated food and beverage system regarding the status of each hold zone position. The identification/checking of the hold zone positions, by the hold zone engine 128, in the hold zone is explained referring to FIG. 8A, FIG. 8B, FIG. 8C and FIG. 8D.

Referring to FIG. 8A illustrates the automated food and beverage serving system 802 containing multiple components configured to deliver beverage such as coffee in accordance with an embodiment of the present disclosure. The region within the vicinity of these components form a hold zone illustrated as “hold zone area” in FIG. 8B. Further, FIG. 8B shows the components including the robotic arm 118, the delivery bay engines 130, a syrup dispenser 126 (i.e. ingredient dispenser 126), the disposal area 134 and a cup disposal stand 804 within the vicinity of the “hold zone area”. These components are collectively configured to prepare a coffee and dispense the coffee to the user 104. The hold zone area could be in any form, such as table surface or cup shelf inside the working zone of the robotic arm 118 as shown in FIG. 8B. The hold zone must be ensured for the reachability of robotic arm 118. The hold zone is used for facilitating the various actions by the robotic arm 118 such as placing a cup, moving a cup and disposing a cup etc. Further, the hold zone position is required to ensured safety as well as there should not be conflicts between different robotic arm actions of placing the cup, getting a cup, moving a cup for placing the cup from origin to hold zone position and moving cup for getting the cup from the hold zone position to origin.

FIG. 8C illustrates various hold zone positions corresponding to the hold zone. As shown in FIG. 8C, the hold zone is capable of supporting six cups of coffee at the same time. However, the capacity of the hold zone positions may be increased depending upon the hold zone area used in the automated food and beverage serving system. More particularly, the bigger surface of table, additional cup shelf or even other form of surface could support a cup placement forming the hold zone according to embodiments of the present disclosure. FIG. 8D shows identification of cup positions. The control system 116, via the hold zone engine 128, may be configured to record and check position of coffee and available positions in the zone. The hold zone engine 128 may determine/identify/check the position of each cup based on angle and distance of each cup from the origin of the robotic arm.

Now referring to FIG. 7B, after the checking of the hold zone position as explained above, at block 740, the control system 116 may check whether the menu item/product is in the hold zone 128. If the menu item is not in the hold zone, then at block 742, the control system 116 may instruct the multiple components shown in FIG. 1A (e.g. the robotic arm 118, the container dispenser 122, the ingredient dispenser 126 and the product/item maker 120) to prepare/produce the order. In one example, the control system 116 may instruct the product/item maker 120 to prepare the menu item based upon product information extracted by the central controller 110. The robotic arm 118 may use an ingredient for making the menu item from the ingredient dispenser 126. The container dispenser 122 may be controlled by the robotic arm 118 in order to dispense the container 124 for accommodating the menu item prepared by the product/item maker 120. The control system 116 may control the order execution via the order production engine 208 shown in FIG. 2. Then order processing engine 208 facilitates execution/processing of the order by using and Ethernet interface between the product/item maker (e.g. a coffee machine or hot cake maker) and the central controller 110. Further, the order processing engine 208 may use TCP/IP protocols as the software interface to control the product/item maker (e.g. a coffee machine or hot cake maker). This maximizes operational reliability and minimizes downtime.

At block 744, based upon the completion of the order, the control system 116 notifies the server 102, via the central controller 110, regarding the completion of the order. At block 746, the order is moved by the robotic arm 118 into the corresponding delivery bay engine 130 for the pick-up of the order by the user.

At block 740, if is determined that the menu item is already present in the hold zone, the control system 116 notifies the server 102, via the central controller 110, regarding the completion of the order at block 748. At block 750, the order present in the hold zone position of the hold zone is moved by the robotic arm 118 into the corresponding delivery bay engine 130. The door of the delivery bay engine 130 may then be opened for the user to pick up the order.

At block 752, status of the hold zone position from which the order was just moved by the robotic arm 118 from the hold zone position to the delivery bay engine 130 for user pickup may be updated by the control system 116. After delivering the order to the user, the status of the corresponding hold zone position is changed as “available” and is therefore available for the automated food and beverage serving system to use for new orders which have completed production. The process for the order execution/processing is then terminated at block 754 as shown in FIG. 7B.

Now again referring to FIG. 7A, if the payment for the order has already being processed and the automated food and beverage serving system determines, via the arrival detection engine 212 (shown in FIG. 2), that the user is nearby or pickup time corresponding to the order placed by the user is near, then the automated food and beverage serving system may execute the order prior to the user arriving at the automated food and beverage serving system based on steps described at blocks 706-730 in FIG. 7A as explained below.

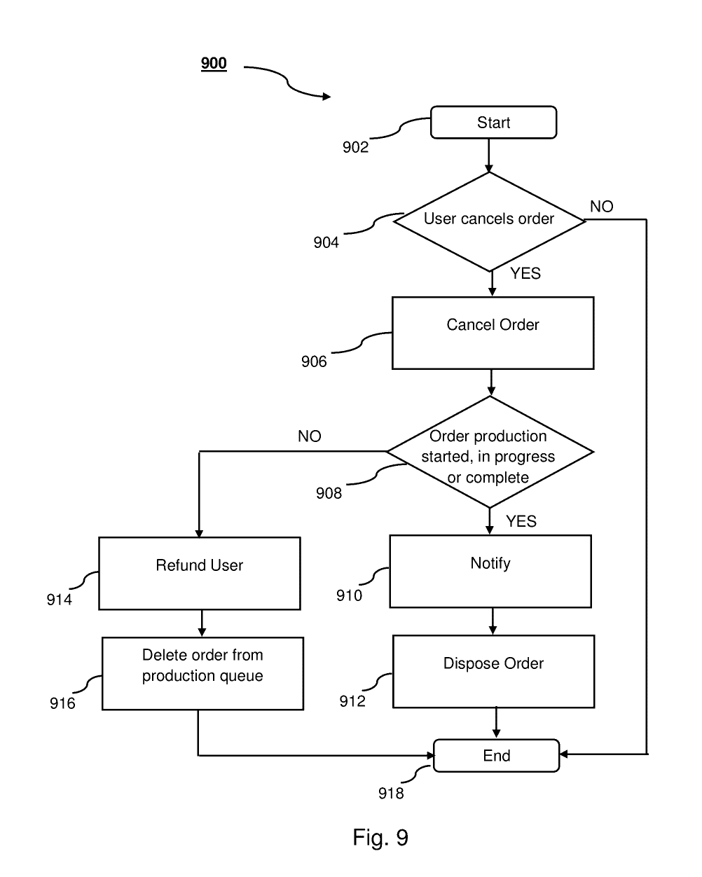

At block 706, the automated food and beverage serving system may execute the order in queue using the allocated components as described above. The automated food and beverage serving system is configured to execute the order when it is time to produce the order in the queue. At block 708, the automated food and beverage serving system may access, via the central controller 110, the order information such as recipe ID and other options selected by the user. At block 710, the automated food and beverage serving system, in response to instructions from the central controller 110, configures the control system 116 to control the allocated components to produce the order as described above. At block 712, the automated food and beverage serving system, via the control system 116, is configured to notify the server 102 about the initiation of the production of the order. At block 714, the user is notified on the user device 104, via the server 102, about the initiation of the production of the order. The notification serves as a reminder for the user in an effort to reduce the time for completed order to wait for pickup in the hold zone. At this stage, the user may still be provided with feasibility of cancelling the order. The details regarding cancelling the order by the user are explained referring to FIG. 9.

Referring to FIG. 9, at block 902, the workflow for cancelling the order workflow is initiated. At block 904, the user may anytime cancel the order already placed via the user device 104. At block 906, the server 102 may be notified that the user has cancelled a particular order via the user device 104. At block 908, the server 102 may be configured to check if the order cancelled by the user is “Not yet started for production” or “in production” or “completed production”. If is determined by the server 102 at block 908 that the order status is “Not yet started for production”, then at block 914, the user is refunded with the amount paid while placing the order. Further, at block 916, after the processing of the refund, the order is deleted from the queue of the automated food and beverage serving system. If is determined by the server 102 at block 908 that the order status is “in production” or “completed production, then at block 910, the server 102 may be configured to notify the automated food and beverage serving system that the order is cancelled by the user. At block 912, the automated food and beverage serving system may locate the position of the order cancelled and move the order to the disposal area 134 within the automated food and beverage serving system. The process of cancelling the order is then terminated at block 918 either from the block 912 or block 916 as shown in FIG. 9.

Now referring to FIG. 7A, at block 716, the server 102 is notified that order production is complete and the order is ready for the user to pickup. At block 718, the server 102 may send a notification on the user device updating the order completion status to the user and that the order placed by the user is ready for pickup. At block 720, the control system 116, via the hold zone engine 128, may check if there are hold zone positions available in the hold zone for placing the produced order. If there is no available hold zone position, then at block 722, the control system 116, via the hold zone engine 128, may check which hold zone position contains the order which has spent the longest time in the hold zone. Since, there is no additional hold zone position to place the current order placed, a hold zone position with an existing order must be cleared. At block 724, the control system 116 may check and record the order number associated to the order which has spent the longest time in a hold zone position. At block 726, the control system 116 may instruct the robotic arm 118 to dispose the order in the hold zone position containing the order for longest time. The robotic arm 118 may be configured to move the order to the disposal area 134 of the automated food and beverage serving system to make the hold zone position available for a new order that has completed production. At block 720, if the control system 116 determines that there is a hold zone position available to place the current order, then at block 728, the control system 116 is configured to record the hold zone position available. At block 730, the control system 116 may instruct the robotic arm 118 to move the order to the hold zone positions made available either through blocks 726 and 728.

Now again referring to FIG. 3, once the order is moved in the hold zone position available as explained above, at block 328, the product/item (menu item) may be delivered to the user via the delivery bay engine 130 shown in FIG. 1A and FIG. 2. The delivery bay engine 130 may employ sensors to detect if an order is present in the delivery bay engine 130. The delivery bay engine 130 may generate “Beverage present” or “beverage empty” events accordingly.

It is to be noted that the triggering of the delivery of the menu item to the user is not only based upon an approach of using the PIN (order identifier) on the display screen 132 of the delivery bay engine 130 as described above and the system 100 may employ alternative approaches for triggering the delivery of the menu item. In one example, the automated food and beverage system may enable the user to enter user/user device identification number (e.g. a phone number, IMEI number and the like) on the display screen 132 that triggers the delivery of the menu item via the delivery bay engine 130. In another example, Bluetooth beacon technology may be implemented by the automated food and beverage serving system to serve the menu item without requiring the user to perform any touch actions on the display screen 132 that triggers the delivery of the menu item via the delivery bay engine 13. In this example, the automated food and beverage serving system may broadcast a system identifier along with a radio frequency (RF) to the user device 104. The user device 104, via the device app, may detect the strength of the signal and supplementary data to confirm the geographical location of the user device 104 within the proximity of the automated food and beverage serving system and thereby the user may pick up the order ready for pick up at the respective delivery bay engine 130. Similarly, various other alternative approaches may be possible in order to trigger the delivery of the menu item to the user in addition to the PIN based approach, the user/device identifier based approach and the RF based approach as described above.

It must be understood that the robotic arm 118 is a hardware component and hence is unable to understand the order itself. In order to complete the order, machine understandable instruction is required. The robotic arm 118 is therefore programmed to define motions or paths stored itself inside the robotic arm 118. In an example, the motions or the paths are those that enable travelling to the container dispenser 122 and obtaining the container 124 for accommodating the menu item produced by the product/item maker 120. These motions and paths will be triggered when the robotic arm 118 receives instructions from a robotic arm engine 210 shown in FIG. 2. In accordance with embodiments of the present disclosure, the actions performed by the robotic arm 118 under the control of the robotic arm engine 210 (shown in FIG. 2) to complete any order may include but not limited to:

Moving the container 124 from the container dispenser 122 to the product/item maker 120.

Moving the processed menu item along with the container 124 from the product/item maker 120 to the Hold Zone.

Deliver the order via the delivery bay engine 130.

Dispose the menu item whose quality has become less fresh in the disposal area 134.

The above actions performed by the robotic arm 118 in response to instructions received from the robotic arm engine 210 (shown in FIG. 2) is further explained with an example. In this example, assume the user has ordered a coffee. The robotic arm engine 210 (shown in FIG. 2) may instruct the robotic arm 118 to open a gripper, move the robotic arm to the container dispenser 122 (e.g. cup hopper in this case), take a cup from the cup hopper, move the cup to the product/item maker 120 (e.g. coffee machine in this case) and start the preparation of the coffee. The robotic arm engine 210 may instruct the robotic arm to set modifications according to order recipe (strength, standard/decaf beans, cup size-SML, milk type, etc.). The robotic arm 118 may handle the error encountered, if any. Further, the robotic arm engine 210 may instruct the robotic arm 118 to move the cup in the hold zone position available in the hold zone and assign the hold zone position number to the order ID pertaining to the coffee for future pick up by the user. The robotic arm engine 210 may instruct the robotic arm to move the order (i.e. coffee) corresponding to the order ID from the hold zone position to an empty delivery bay engine 130. A sensor in the delivery bay engine130 is configured to flash a light indicating the availability of the order in the delivery bay engine 130. The robotic arm engine 210 may instruct the robotic arm 118 to close the door of the delivery bay engine 130 after the cup is taken out by the user and the light flashed is automatically turned OFF.

Referring to FIG. 2, the automated food and beverage serving system further comprises a Real time health monitoring engine 214 and a Remote maintenance and control engine 216. The Real time health monitoring engine 214 is configured to notify/update real time status of the automated food and beverage serving in order to ensure all components are working effectively and efficiently. In some embodiments, the notification and/or updating of the status is enabled via reports which may be delivered to relevant persons by SMS or email for prompt action if an error is encountered thus minimizing the downtime. The Remote maintenance and control engine 216 may be configured to monitor and diagnose application and system data, install and distribute software and data, and carry out remote training courses.

In accordance with various embodiment of the present disclosure, various sensors (not shown in Figures) are used to provide closed-loop control to ensure an operation is complete with a pre-defined controllable state. It is to be noted that the sensors may be used in the delivery bay engines, the order production components, the proximity detection, the holding zone and the servicing doors of the delivery bay engines. The various engines as described above are capable of operating automatically and concurrently thereby facilitating multiprocessing. Further, the system 100 described above is a time-triggered system that is capable of executing one or more tasks/functions according to pre-determined task schedule. The system 100 supports an event driven architecture in which the flow of the program is determined by events. No process is required to poll for statuses or incoming processes. Each engine acts asynchronously according to the event received. This approach yields a high operating efficiency of the central controller 110 of the automated food and beverage serving system. The system 100 may further support a Message-based inter-process communication by introducing a layer between processes, message queues create an implicit, data-based interface that both processes implement. This allows to extend and modify these processes independently, by simply ensuring they adhere to the same interface requirements. Because message queues decouple processes, it is easy to scale up the rate at which messages are added to the queue or processed by simply adding another process. No code is required to be changed nor is change in configuration.

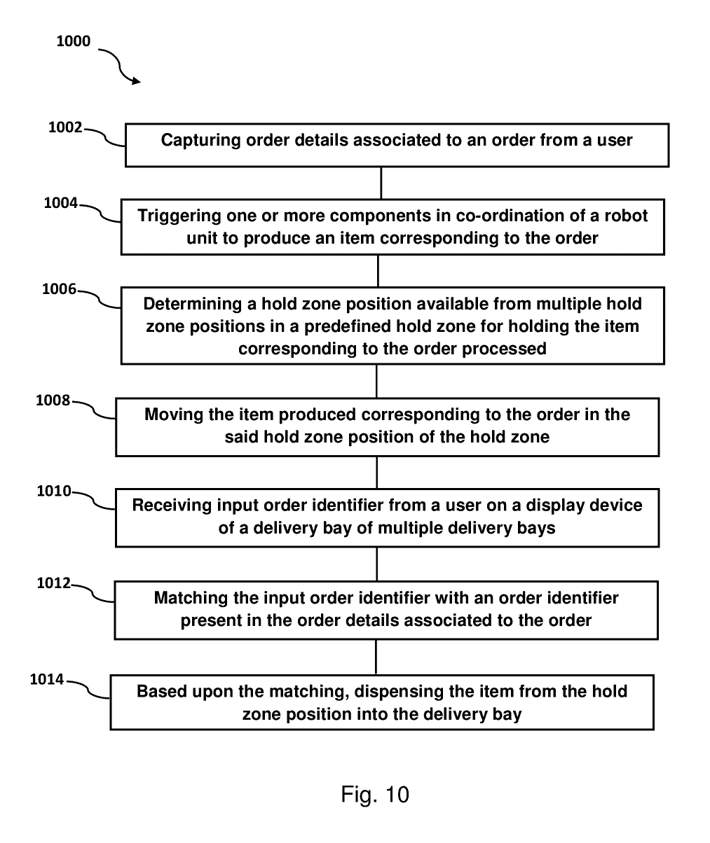

Referring now to FIG. 10, a method 1000 for automated serving of one or more items (e.g. food and beverages) to the user is shown, in accordance with an embodiment of the present subject matter. The order in which the method 1000 is described is not intended to be construed as a limitation, and any number of the described method blocks can be combined in any order to implement the method 1000 or alternate methods. Furthermore, the method 1000 can be implemented in any suitable hardware, software, firmware, or combination thereof. However, for ease of explanation, in the embodiments described below, the method 1000 may be considered to be implemented in the above described system 100.

At block 1002, order details associated to an order placed by a user may be captured by the central controller 110. The order may be placed by the user via the user device 104 to a server 102 communicatively coupled with the said central controller 110. The order details may at least comprise an order identifier associated to the order.

At block 1004, one or more components in co-ordination with a robot unit 118 may be triggered to produce an item corresponding to the order. The user may be notified about the current stage of processing of the order right from initiation until the successful completion of processing of the order. In one implementation, the one or more components in co-ordination with the robot unit 118 may be triggered by the control system 116 in response to one or more programmed instructions executed by the central controller 110. Further, the user is notified by the control system 116 via the server 102.

At block 1006, a hold zone position available from multiple hold zone positions in a predefined hold zone for holding the item corresponding to the order processed may be determined. In one implementation, the hold zone position available is determined by the control system 116 in response to one or more programmed instructions executed by the central controller 110.

At block 1008, the robot unit 118 may be instructed to move the item produced corresponding to the order in the said hold zone position of the hold zone. In one implementation, the robot unit 118 may be instructed to move the item by the control system 116 in response to one or more programmed instructions executed by the central controller 110.

At block 1010, an input order identifier may be received from the user. In one implementation, the input identifier may be received on a display device of a delivery bay engine 130 of multiple delivery bay engines 130.

At block 1012, the input order identifier may be matched with the order identifier present in the order details associated to the order. In one implementation, the input order identifier may be matched with the order identifier by the control system 116 in response to one or more programmed instructions executed by the central controller 110.

At block 1014, the item may be dispensed from the hold zone position into the delivery bay engine 130 based upon the matching of the input order identifier with the order identifier. In one implementation, the robot unit 118 may be instructed to dispense the item by the control system 116 in response to one or more programmed instructions executed by the central controller 110.

Although implementations for methods and systems for automated serving of one or more items have been described in language specific to structural features and/or methods, it is to be understood that the appended claims are not necessarily limited to the specific features or methods described. Rather, the specific features and methods are disclosed as examples of implementations for automated serving of one or more items.

What is claimed is:

1. A system for automated serving of one or more items, the system comprising:
a central controller coupled to a memory storing programmed instructions capable of being executed by the central controller, wherein the central controller executes a programmed instruction to capture order details associated to an order placed by a user for serving an item;
a control system electronically coupled with the central controller, wherein the control system, in response to one or more programmed instructions executed by the central controller, is configured to
trigger one or more item producing components along with a robot unit to collectively process the order in order to produce the item based upon the order details associated to the order and
determine a hold zone position available from multiple hold zone positions in a predefined hold zone for holding the item corresponding to the order processed; and
the robot unit, in response to instructions received from the control system, is configured to
move the item produced corresponding to the order in the said hold zone position of the hold zone; and
dispense the item from the said hold zone position into a delivery bay engine of a plurality of delivery bay engines thereby serving the item to a user.

2. The system of claim 1, wherein the order is placed via a user device of the user to a server communicatively coupled with the said central controller, wherein the order placed is confirmed based upon successful processing of payment via a payment gateway on the server.

3. The system of claim 2, wherein the order details are stored in the server corresponding to the order, and wherein the order details comprises a unique order identifier, the item selected, an item identifier, a pick-up time, customized options selected by the user for producing the item, and payment details.

4. The system of claim 3, wherein the item corresponding to the order is produced based upon the customized options selected by the user, and wherein the item is produced prior to expiry of the pick-up time, and wherein the one or more components, producing the order in co-ordination with the robot unit, comprises at least one of an item maker, a container dispenser and an ingredient dispenser.

5. The system of claim 1, wherein the hold zone position available is either a hold zone position free from any order or a hold zone position holding a previous order for a longest time as compared to other hold zone positions in the hold zone.

6. The system of claim 5, wherein the control system is further configured to instruct the robot unit to dispose the previous order held in the hold zone position thereby making the hold zone position available for holding the said order.

7. The system of claim 6, wherein the control system is further configured to record the hold zone position available in the hold zone and thereby associate the hold zone position recorded to the said order.

8. The system of claim 1, wherein the robot dispenses the item by
rotating the said delivery bay engine in the direction of the user and
opening the door of the said delivery bay engine in order to provide the item available for pick-up by the user.

9. The system of claim 2, wherein the control system is further configured to notify on the user device, via the server, status indicative of initiation of the processing of the order, current stage of the processing of the order and successful completion of the processing of the order, wherein based upon the successful completion of the processing of the order, the user is notified regarding the availability of the item for pick-up at the said delivery bay engine.

10. The system of claim 8, wherein the said delivery bay engine of the plurality of delivery bay engines is selected for dispensing of the order based upon receipt of an input order identifier from the user on a display device of the said delivery bay engine, and wherein the order is dispensed after the matching of the input order identifier with the order identifier contained in the order details associated to the said order.

11. The system of claim 3, wherein the server is configured to prioritize the order in a queue of multiple orders placed on the said server, and wherein each order is prioritized in the queue based upon the pick-up time associated with each order.

12. A method for automated serving of one or more items, the method comprising:
capturing, via a central controller, order details associated to an order placed by a user for serving an item;
triggering, via a control system electronically coupled to the central controller, one or more item producing components along with a robot unit to collectively process the order in order to produce the item based upon the order details associated to the order;
determining, via the control system, a hold zone position available from multiple hold zone positions in a predefined hold zone for holding the item corresponding to the order processed;
moving, via the robot unit, the item produced corresponding to the order in the said hold zone position of the hold zone; and
dispensing, via the robot unit, the item from the said hold zone position into a delivery bay engine of a plurality of delivery bay engines thereby serving the item to a user.

13. The method of claim 12, wherein the order is placed by a user, via a user device of the user, to a server communicatively coupled to the central controller, and wherein the order placed is confirmed based upon successful processing of payment via payment gateway on the server, wherein the server stores the order details comprising at least a unique order identifier, the item selected, an item identifier, a pick-up time, customized options selected by the user for producing the item, and payment details.

14. The method of claim 13, wherein the item corresponding to the order is produced based upon the customized options selected by the user, and wherein the item is produced prior to expiry of the pick-up time, and wherein the one or more components, producing the order in co-ordination with the robot unit, comprises at least one of an item maker, a container dispenser and an ingredient dispenser.

15. The method of claim 12, wherein the hold zone position available is either a hold zone position free from any order or a hold zone position holding a previous order for a longest time as compared to other hold zone positions in the hold zone.

16. The method of claim 15 further comprising instructing the robot unit, by the control system, to dispose the previous order held in the hold zone position thereby making the hold zone position available for holding the said order.

17. The method of claim 12 further comprising recording, via the control system, the hold zone position available in the hold zone and thereby associate the hold zone position recorded with the order.

18. The method of claim 12, wherein the robot dispenses the item by
rotating the said delivery bay engine in the direction of the user and
opening the door of the said delivery bay engine in order to provide the item available for pick-up by the user.

19. The method of claim 13 further comprising notifying, by the control system, on the user device, via the server, status indicative of initiation of the processing of the order, current stage of the processing of the order and successful completion of the processing of the order, wherein based upon the successful completion of the processing of the order, the user is notified regarding the availability of the item for pick-up at the said delivery bay engine.

20. The method of claim 18 further comprising selecting, by the control system, the said delivery bay engine of the plurality of delivery bay engines for dispensing of the order based upon receipt of an input order identifier from the user on a display device of the said delivery bay engine, and wherein the order is dispensed after the matching of the input order identifier with the order identifier contained in the order details associated to the said order.
